(19) United States
(12) Patent Application Publication
(10) Pub. No.: US 2020/0279341 A1
(43) Pub. Date: Sep. 3, 2020

(54) SYSTEM AND METHOD FOR LAND LEASING

(71) Applicant: Cash Rent, LLC, Morton, IL (US)

(72) Inventors: Chris Baumann, Morton, IL (US); Brad Belser, Peoria, IL (US)

(21) Appl. No.: 16/806,556

(22) Filed: Mar. 2, 2020

Related U.S. Application Data
(60) Provisional application No. 62/812,536, filed on Mar. 1, 2019.

(51) Int. Cl. G06Q 50/16; G06Q 30/06; G06Q 50/18; G06Q 10/10; G06Q 20/10; G06Q 30/08; G06Q 50/02; G06Q 30/00; G06F 16/9535; G06F 16/9537

(52) U.S. Cl. CPC G06Q 50/165; G06Q 30/0645; G06Q 50/188; G06Q 10/10; G06F 16/9537; G06Q 30/08; G06Q 50/02; G06Q 30/018; G06F 16/9535; G06Q 20/108

(57) ABSTRACT

The invention comprises a networked computer system comprising an operating system and graphical user interface configured with a plurality of software subroutines configured operate an online marketplace for leasing farmland. The plurality of subroutines is further configured to interact with internal and external databases to map soil types and land topography while providing real time price per square footage data and availability.

### CROSS-REFERENCE TO RELATED APPLICATIONS

The present application claims priority to commonly assigned co-pending U.S. provisional application Ser. No. 62/812,536 filed Mar. 1, 2019, herein incorporated by reference in its entirety.

### BACKGROUND OF THE INVENTION

The present invention generally relates to e-commerce land leasing and cash rent systems. More particularly, the present invention relates to an e-commerce transactional marketplace utilized to discover, vet and lease farmland.

In the prior art, in order for a landowner to prepare his land for leasing, the landowner traditionally would have to identify general geographic areas that the landowner was interested in leasing, drive to the county Farm Service Agency (FSA) office and manually pull FSA maps from county records. The landowner would next have to pay a soil testing company and/or a soil mapping firm to generate a soil map. If the landowner was the lessor, he would have to manually prepare a listing sheet with all pertinent land data for a potential lessee landowner and drop off that listing sheet at a local agriculture related office with the lessor's relevant contact information. The lessor would then be responsible for fielding all lessee inquiries by phone or email and manually keep track of all lessees until a decision to lease was made. At that point the lessor would have to hire an attorney to create a cash rental agreement/contract and meet with the lessee to review and sign the contract.

These traditional farmland leasing steps and methods are costly and time consuming to both the lessor and the lessee. A system is needed to centralize all steps involved in the leasing process that will allow a landowner to quickly generate FSA and soil maps, generate listings and custom parcels, market and distribute listings, facilitate lessor and lessee communication, and generate and automate leasing contracts.

### SUMMARY OF THE INVENTION

Described herein are embodiments of systems and methods for a land lease marketplace driven by networked computing devices configured to compile land data and lease data to simplify the Lessee and Lessor experience. These systems may be implemented using a variety of hardware and may interact with transaction administrators, users, user vendors, user customers and other applicable and/or necessary parties to improve the user processes, capture available information and revenue and otherwise overcome the limitations, shortcomings and disadvantages of known systems and methods.

Software operates as a set of instructions running in executable memory of a processor residing on a computing device. It is to be recognized by one of skill in the art that the terms “software,” “app,” “module,” “routine,” or “sub-routine” may be used interchangeably in this specification to describe software or one or more component parts thereof. In some embodiments of the present invention, each described module or routine/sub-routine is a component part of a larger set of software instructions while in other embodiments each described module or routine/sub-routine act as independent software applications. It is to be recognized by one of skill in the art that the categorization of “modules” is merely for explanation and organizational purposes. It is also to be recognized by one of skill in the art that the terms “database” or “datastore” as used may describe a single specific database, or a sub-section of a larger database.

In a first embodiment the system comprises a computer (a non-transitory computer-readable storage medium having computer-executable program instructions stored thereon capable of being executed by a processor) or a backend cloud server and networked devices (non-transitory computer-readable storage mediums having computer-executable program instructions stored thereon capable of being executed by a processor) configured with a graphical user interface (GUI) and plurality of communicatively coupled software modules configured to administer an online land leasing marketplace. Networked devices may include but are not limited to cell phones, handheld devices, portable tablets, portable computers, or additional computers. It is to be recognized by one of skill in the art that the GUI may be accessible through any networked device through the internet such as a World Wide Web portal or locally through installed software or an app.

In one aspect of the system, the GUI includes an administration portal (ADP) and a Lessee Portal (LSP) and a Lessor Portal (LRP). The ADP is a subroutine configured to allow the system administrator to oversee and control system users and interaction between users. The LSP and LRP are subroutines configured to provide a Lessee or Lessor access and management to land lease transactional data, search for land or lease data, and communicate with other users or system administrators. In some embodiments the LSP and LRP are part of the same subroutine but provisioned to provide different GUI representations depending on the type of user that logs into the system.

In another aspect of system, the system includes a User Registration Module (URM) that is available on or accessible through a computer or networked device. The URM is a data collection module configured to collect information regarding a user whether the user is a land lessee or land lessor. The URM may collect data including but not limited to login names, passwords, first and last names, telephone numbers, addresses, and land lease preferences and store the data in a URM database. The URM database may be used by the ADP to manage all system global transactions among users, and used by the LSP and LRP to manage transactions between parities interested in negotiating a land lease.

In another aspect of system, the system includes a Land Data Collection Module (LDCM) that is available on or accessible through a computer or networked device. The LDCM may be accessible through the ADP, LSP or LRP and in some aspects acts as a data collection module and in other aspects acts as a data analysis module. The LDCM is configured connect to internal and external land information databases to provide among other data, soil types and soil maps, crop types, average yield, and seasonal data, for a particular user identified parcel of land and build a land parcel profile. The LDCM may be additionally configured to pull data including average price for acreage in a particular area, and lease terms. The complied data may be stored in a LDCM database and accessed and modified through the any of the modules described above.

In some aspects of the system, a Lessor may log into the LRP through the GUI on a connected device and execute the LDCM to create a land parcel profile subject to leasing conditions that is accessible through the LSP. In this embodiment, the Lessor creates a new land parcel profile and identifies the geographic location of the land parcel. In some embodiments the land parcel may be identified visually and drawn on a digital map through the GUI, while in other embodiments the metes and bounds of the parcel may be pulled through executing a search routine through the LDCM pulling the publically stored data from an external database or by manually entering in GPS coordinates defining the metes and bounds of the parcel. After the Lessor creates the geographical map of the land parcel, the Lessor may populate the profile with the additional land data pulled by the LDCM, as described above, manually enter property information such as a title, an image, soil types, topography, legal descriptions and set land lease requirements.

In other aspects, the invention comprises a method for land leasing comprising the steps of initiating a plurality of software subroutines configured to create and display land lease data, initiating a software subroutines to identify a parcel of land for lease, connecting to an internal or external database to populate land data including but not limited to soil type and topography, setting lease provisions, and creating a lease posting with the collected data. Additionally, the method may comprise the steps of initiating a plurality of software subroutines configured to search for and display land lease data, searching for a land lease based on search parameters including but not limited to location, soil type, crop type, and topography, initiating a bidding subroutine configured to negotiate the terms of the land lease, and executing a digital land lease contract.

In another aspect of the system, a Lessee may log into the LSP through the GUI on a connected device and execute the LDCM to browse land parcel profiles for potential leasing opportunities. In this embodiment, the Lessee may enter identifying search data including but not limited to address or zip code, soil type, crop type, lease type, or pricing data into the LDCM to pull land parcel profiles. The Lessee, through the GUI may draw on particular land parcels and get localized data reflecting the data pulled above. After selecting particular parcel, the Lessee may have the option to place bids on the land lease or contact the Lessor.

### BRIEF DESCRIPTION OF THE DRAWINGS

In the accompanying figures, like elements are identified by like reference numerals among the several preferred embodiments of the present invention.

FIG. 1 is a flow chart detailing a hardware embodiment of the system.

FIG. 2 is a flow chart detailing an embodiment of the software modules of the system.

FIG. 3 is a flow chart detailing an alternate embodiment of the software modules of the system.

FIG. 4A is a flow chart detailing the User Registration Module.

FIG. 4B is a flow chart detailing an alternate embodiment of the User Registration Module.

FIG. 5 is a flow chart detailing the land listing process flow.

FIGS. 6A-6C is a flow chart detailing the land bidding process flow.

FIGS. 7A-J represent examples of the system GUI.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known customary practice within the art to which the invention pertains.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

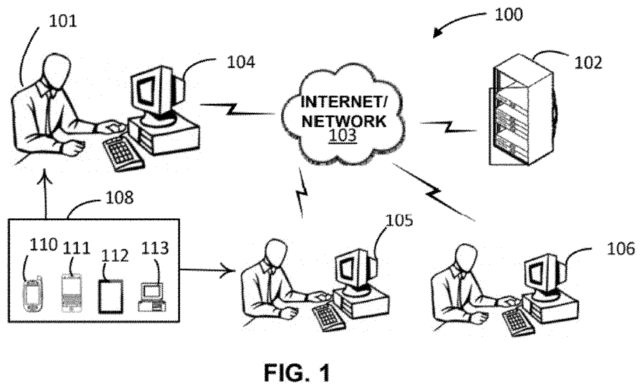

To fully enable the software and its functionality described herein, the present disclosure begins with a summary of how computers may be used, either alone or in a networked configuration. FIG. 1 illustrates a hardware configuration 100 wherein a system and method for Electronic Payment Processing and Risk Analysis is implemented by managing a payment platform system used by different merchants and customers 101 connected over a network 103. The network 103 is suitable for connecting the one or more computers 104, 105 and 106, or mobile devices 110, 111, 112 and 113 and may comprise one or more networks such as a local area network (LAN), a wide area network (WAN) such as the Internet, telephone networks, including telephone networks with dedicated communication links and/or wireless links, and wireless networks. In the illustrative example shown in FIG. 1, the network 103 is the Internet. Each of the one or computers 104, 105 and 106, or mobile devices 110, 111, 112 and 113 is connected to the network 103 via a suitable communication link, such as a dedicated communication line or a wireless communication link.

In an embodiment, the system may be implemented using software that is either local or operating from a remote server such as a web server or cloud server over the Internet. Further, with the rapid growth of Internet technology and portable wireless technology, other computing devices, such as, but not limited to, cell phones, handheld devices, different portable tablets, or portable computers, may be used in place of or in addition to the one or more computers.

Each of the one or more computers 104, 105 and 106, comprises a central processing unit (CPU), an input/output (I/O) unit, a display device communicatively coupled to the I/O unit, a storage device, and a memory. Each of the one or more computers 104, 105 and 106, or mobile devices 110, 111, 112 and 113 may further comprise one or more standard input devices such as a keyboard, a mouse, speech processing means, or a touchscreen.

The memory includes a Graphical User Interface (GUI) that is used to convey information to and receive information from a user of the one or more computers 104, 105 and 106, or mobile devices 110, 111, 112 and 113 via the display device and I/O unit as described herein. The GUI includes any user interface capable of being displayed on a display device including, but not limited to, a web page, a display panel in an executable program, or any other interface capable of being displayed on the one or more computers 104, 105 and 106, or mobile devices' 110, 111, 112 and 113 respective display devices.

As will be recognized by one of skill in the art, each of the cell phones 110, hand-held devices 111, different portable tablets 112, or computers 113 may be configured similarly to the one or more computers 104, 105 and 106, or mobile devices 110, 111, 112 and 113, taking into account the various design considerations of these respective devices.

The GUI may be transmitted to the one or more computers 104, 105 and 106, or mobile devices 110, 111, 112 and 113 or other devices via the network 103. In one embodiment in accordance with the present invention, the GUI is displayed using commercially available hypertext markup language (“HTML”) viewing software such as, but not limited to, MICROSOFT INTERNET EXPLORER, GOOGLE CHROME, APPLE SAFARI, OR MOZILLA FIREFOX, or any other commercially available HTML viewing software.

The GUI may reside on a remote server or within the local hardware of the device. The remote server 102 may comprise one or more separate servers or may be a web server. The remote server 102 may comprise a CPU, memory, and separate storage device and be communicatively coupled to the network 103. The remote server 102 may contain an information storage device that may be a relational database, such as MICROSOFT's SQL or any other database.

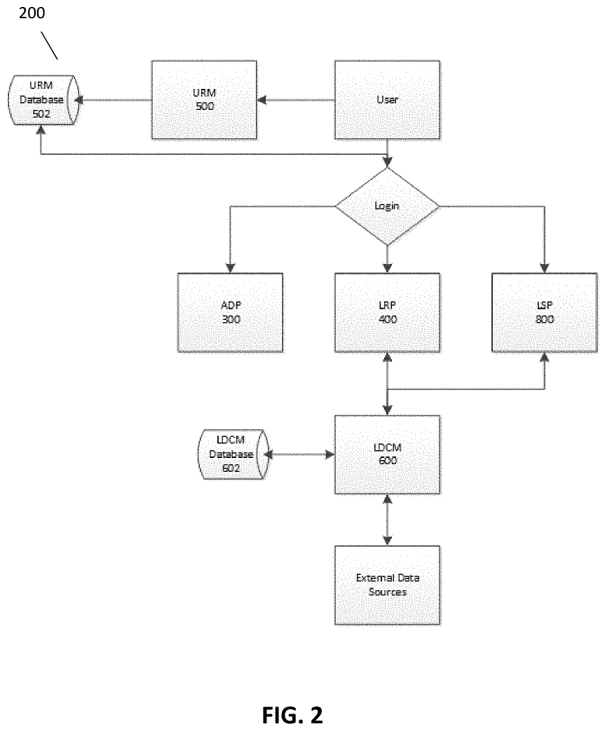

In a first embodiment the system 200, as illustrated in FIG. 2, comprises a local computer or a backend cloud server configured with a GUI having an Administration Portal (ADP) 300 a Lessor Portal (LRP) 400 and a Lessee Portal (LSP) 800 communicatively coupled to a plurality of subroutines. The plurality of subroutines may include the ADP 300 configured to oversee users and control of the system 200, a User Registration Module (URM) 500 configured to collet user registration data, a Land Data Collection Module (LDCM)) 600 configured to collect and analyze user entered or user requested land parcel data, while the LSP 800 and LRP 400 are subroutines configured to provide a Lessee or Lessor access and management to land lease transactional data, search for land or lease data, and communicate with other users or system administrators. Each respective module and subsequent collected data may be communicatively connected to share data through the system 200.

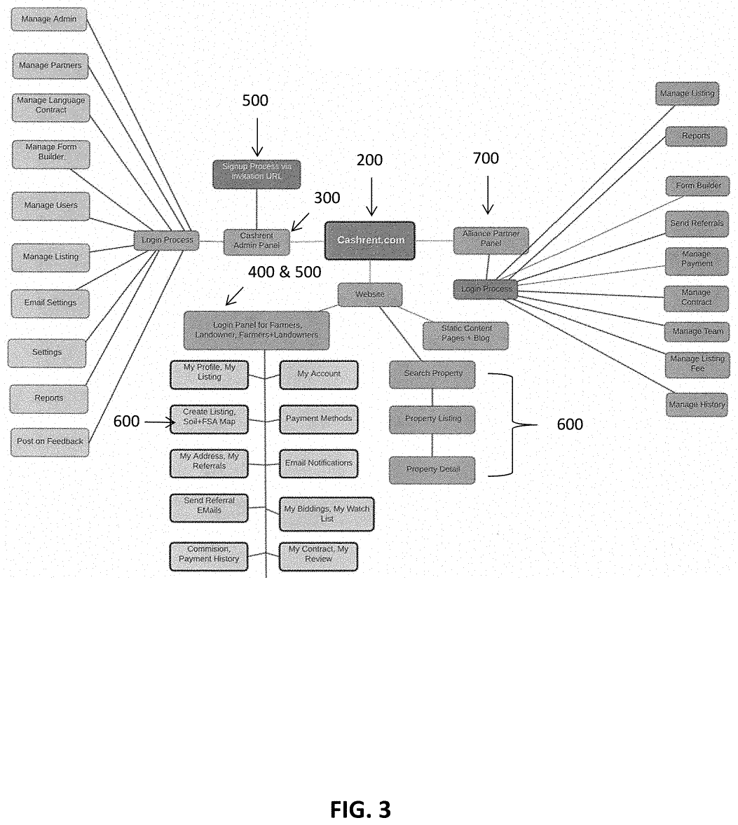

FIG. 3 illustrates an alternate embodiment or architecture of the system described above. As illustrated in FIG. 3, the LRP 400, LSP 800 and LDCM 600 are not separate portals so much as different profiles provisioned to be displayed by the GUI depending on whether the user is a Lessee or Lessor. In this embodiment an additional partner administration module (PAM) 700 is added to allow larger leasing agents controlling multiple parcels of land additional management features as shown.

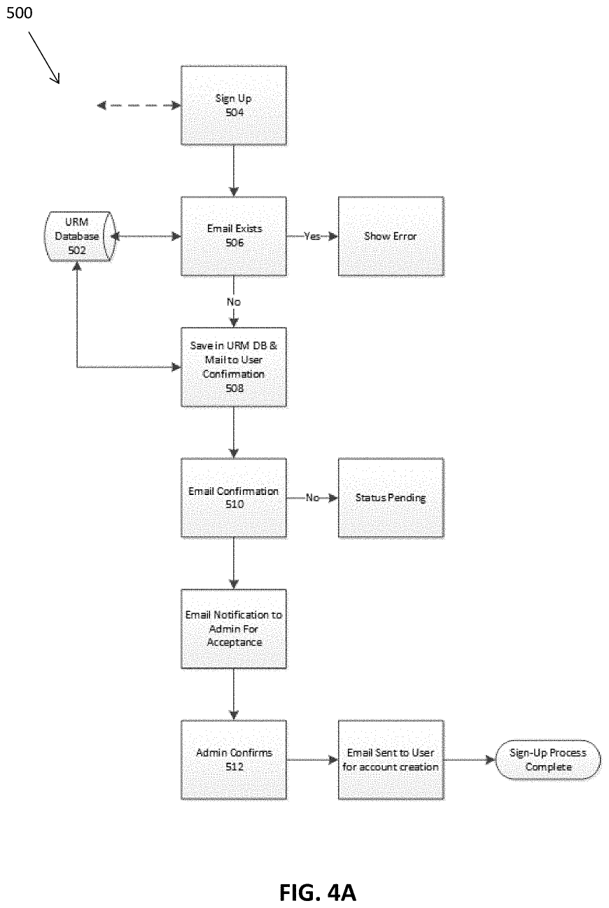

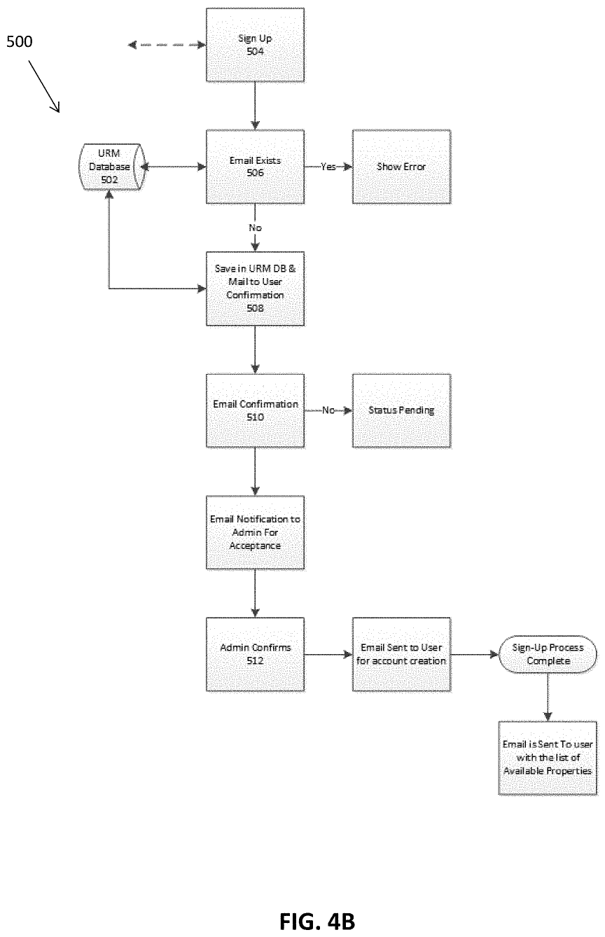

As described above, the User Registration Module (URM) 500 is available on or accessible through a computer or networked device. The URM 500 is a data collection module configured to collect information regarding a user whether the user is a land lessee or land lessor. The URM 500 may collect data including but not limited to login names, passwords, first and last names, telephone numbers, addresses, and land lease preferences and store the data in a URM database 502. The URM database 502 may be used by the ADP 300 to manage all system global transactions among users, and used by the LRP 400 and LSP 800 to manage transactions between parities interested in negotiating a land lease. FIG. 4 illustrates an example process flow of the URM 500. In operation, a user reaches the signup screen 504 of the GUI and enters identifying data such as an email address. The URM 500 executes a search subroutine 506 to see if the identifying information exists within the URM database 502, if the information exists, the URM 500 returns an error message to the user through the GUI letting the user know that the user may already be registered. If the information does not exist within the URM database 502 the system URM 500 saves the identifying data through a data saving subroutine 508 into the URM database 502 and executes a personal data validation subroutine 510. The personal data validation subroutine 510 may for example, send an email, sms message, or phone call with a link to the user to validate the entered data. Upon validation through the data confirmation subroutine 510, the ADP 300 is notified to alert an administrative user to run a confirm account 512 subroutine, complete the account, and notify the new user. Alternative embodiments of the URM 500 may include additional subroutines that immediately notify users of available properties within their respective areas, or preset criteria including but not limited to price, location, soil type and crop type. The notifications may come upon registration, properties that become available after registration, or at set intervals.

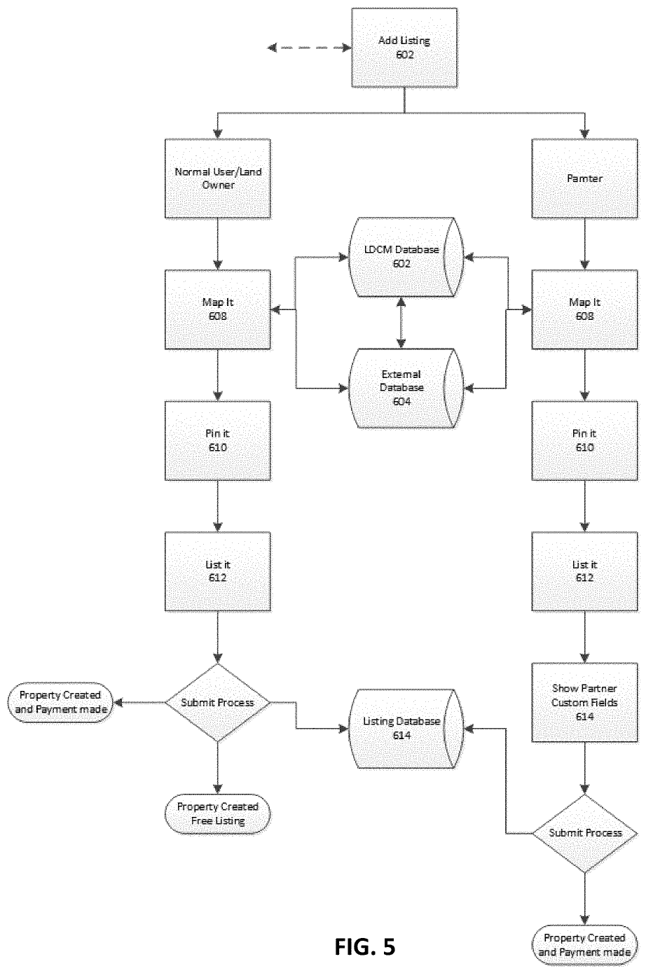

Once a user, whether a Lessee, Lessor, or Partner is registered through the URM 500, the user may access the system 200 through the LRP 400, LSP 800 or the PAM 700 and begin the process of listing properties or browsing properties to lease. The user through the LSP 800 or the PAM 700 may initiate the Land Data Collection Module (LDCM) 600 through a computer or networked device to connect to internal and external land information databases to provide among other data, soil types and soil maps, crop types, average yield, and seasonal data, for a particular user identified parcel of land and build a land parcel profile. The LDCM 600 may be additionally configured pull data including average price for acreage, and lease terms. The complied data may be stored in a LDCM database 602 and accessed and modified through any provisioned modules described above. FIG. 5 illustrates the listing adding process through the LDCM 600 for both Lessor and partner users. As shown in FIG. 5, the user executes an add listing subroutine 606 which prompts a user to begin the mapping subroutine 608. The mapping subroutine 608 is configured to allow a user to draw or identify an area of map, and connect to the LDCM Database 602 or External Database 604 (including but not limited industry standard mapping databases such as AGRIDATA or SURETY MAPS to gather and return relevant soil and FSA maps pertaining to the identified land area. In some embodiments after the LDCM 600 may store the data retrieved from the External Database 604 in the LDCM Database 602 and the LDCM 600 may be configured to periodically scan the External Database 604 for changes in the land area data, and update the data stored in the LDCM Database 602 accordingly. Once a land parcel is mapped, the Pin-it subroutine 610 is executed. The Pin-it subroutine 610 is configured to allow a user to visually pin point the location of leased land to onto a map through the GUI and generate a state recognized address by the location of the pin. Upon completion of the Pin-it subroutine 610, the user may execute the List it subroutine 612. The List it subroutine 612 is configured to store the listing data in the listing database 614 for retrieval and interaction by a potential lessee.

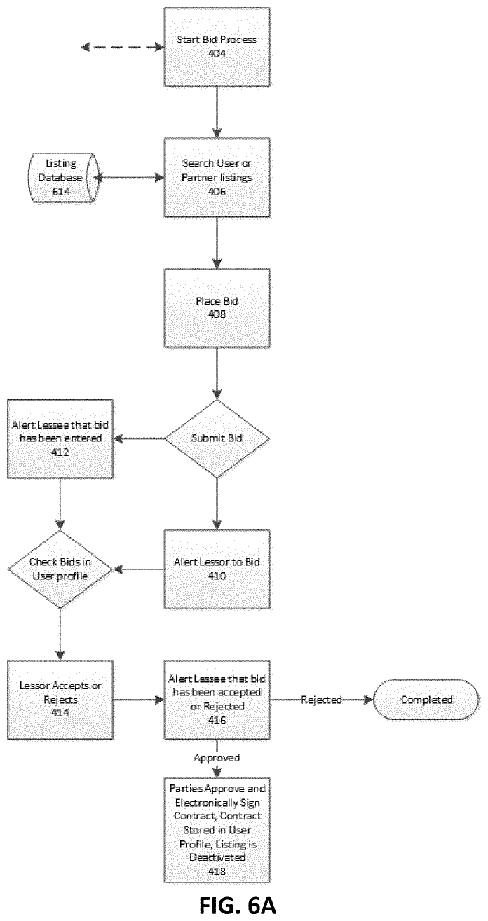

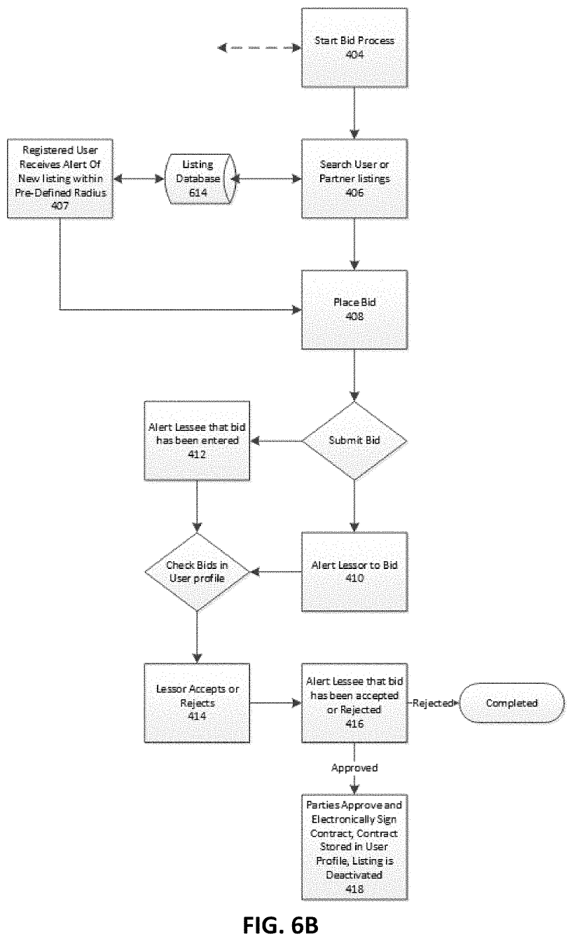

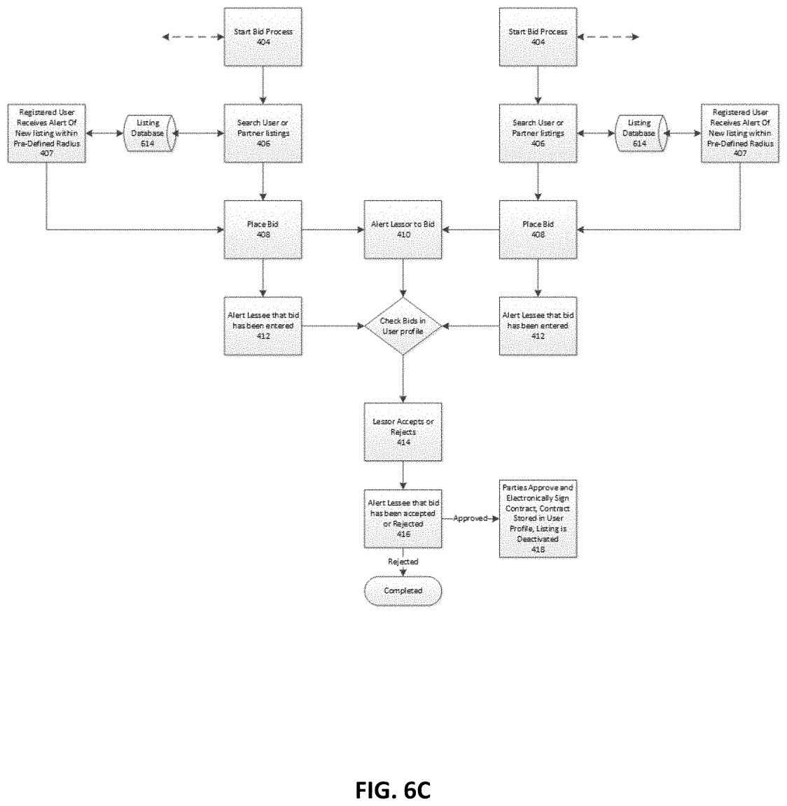

Once a listing is created through the LRP 800 and LDCM 600, a Lessee may log into the LSP 400 through the GUI on a connected device and execute the LDCM 600 to browse land parcel profiles for potential leasing opportunities or to place bids on land parcels available to lease. After selecting particular parcel, the Lessee may have the option to place bids on the land lease or contact the Lessor. FIGS. 6A-C detail the process flows of a Lessee through the LSP 400 while making a bid on a parcel of land. The Lessee first initiates the start bid subroutine 404 and begins the search process 406. The search process 406 may include search parameters including but not limited to address or zip code, soil type, crop type, lease type, or pricing data into the LDCM 600 to pull land parcel profiles. In some embodiments of the search process 406, the Lessee, through the GUI may draw on particular land parcels and get localized data reflecting the data pulled above. After a Lessee finds a desirable land parcel through the search process 406, the Lessee may initiate a place bid subroutine 408 configured as a data collection module in which the Lessee may enter custom bidding terms or accept the listing as offered. Upon submitting a bid through the place bid subroutine 408, the alert Lessor and Lessee that the bid has been entered subroutines 410, 412, are initiated and configured to send the Lessor or Lessee an alert including but not limited to an email, sms message, or phone call. Upon receiving the alert 412, the Lessor is able to log into the LSP 800 view the bid, and initiate and accept or reject bid subroutine 414. Upon accepting or rejecting the bid, the Lessee is alerted through and accept or reject bid alert subroutine 416 including but not limited to an email, sms message, or phone call. If the bid is accepted, the system initiates a contract management subroutine 418 configured to allow both the Lessee and Lessor to execute the lease, store the contract in the listing database, make the contracts accessible through the LSP 800 and LRP 400 and deactivate the listing. FIG. 6B shows an additional embodiment where the Lessee initiates the bidding process through a new listing alert subroutine 407 that notifies the Lessee when a new listing pops up in a predefined radius. In alternative embodiments, the alert subroutine 407 may be defined by soil map or price per square foot as opposed to radius. FIG. 6C shows an additional embodiment where multiple users may bid on the same land parcel and the Lessor may accept or reject multiple bids.

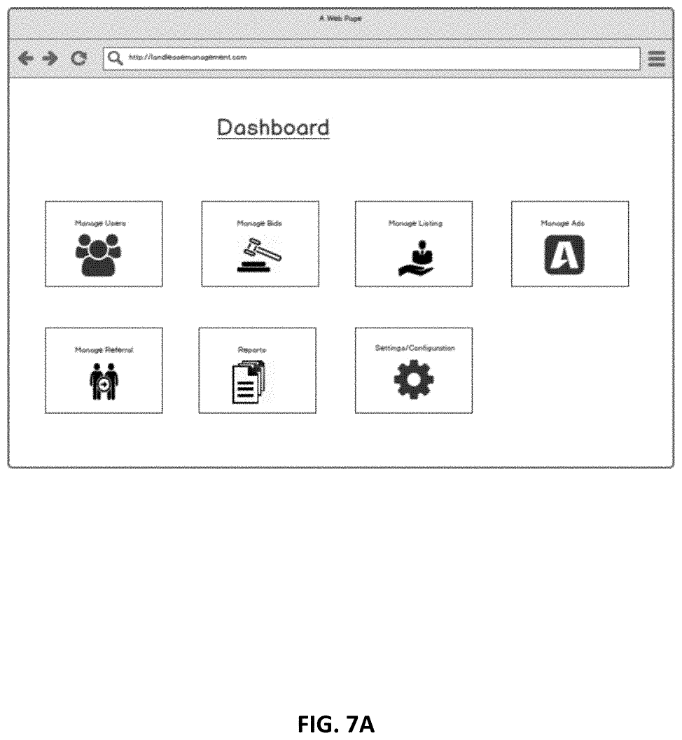

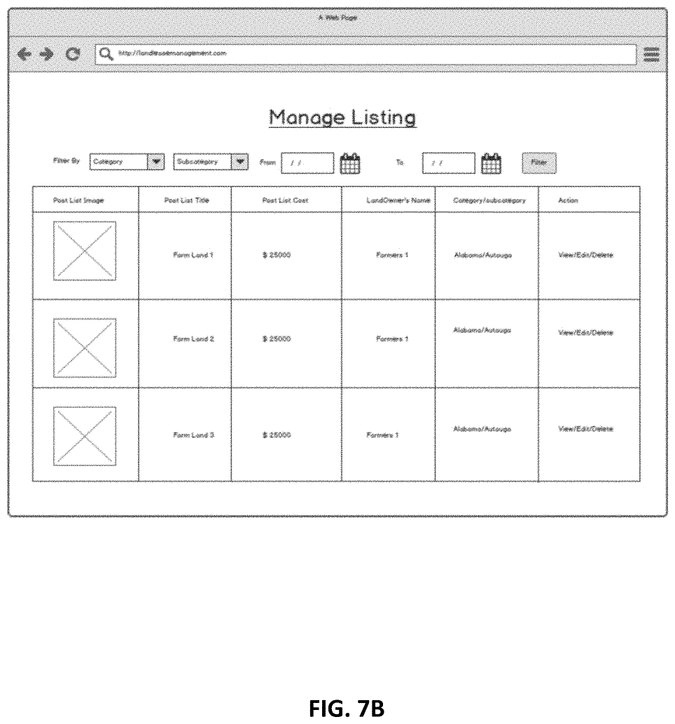

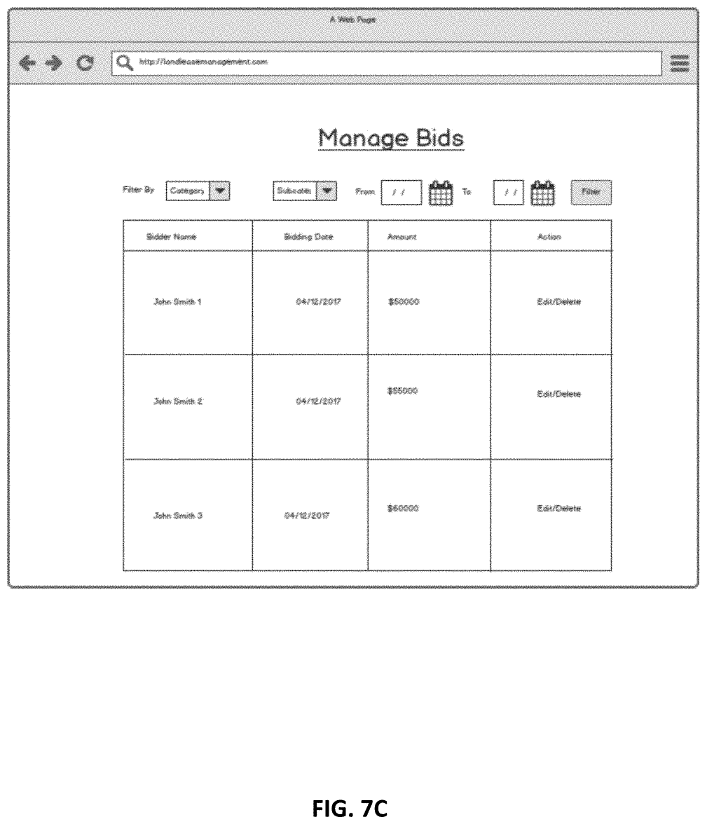

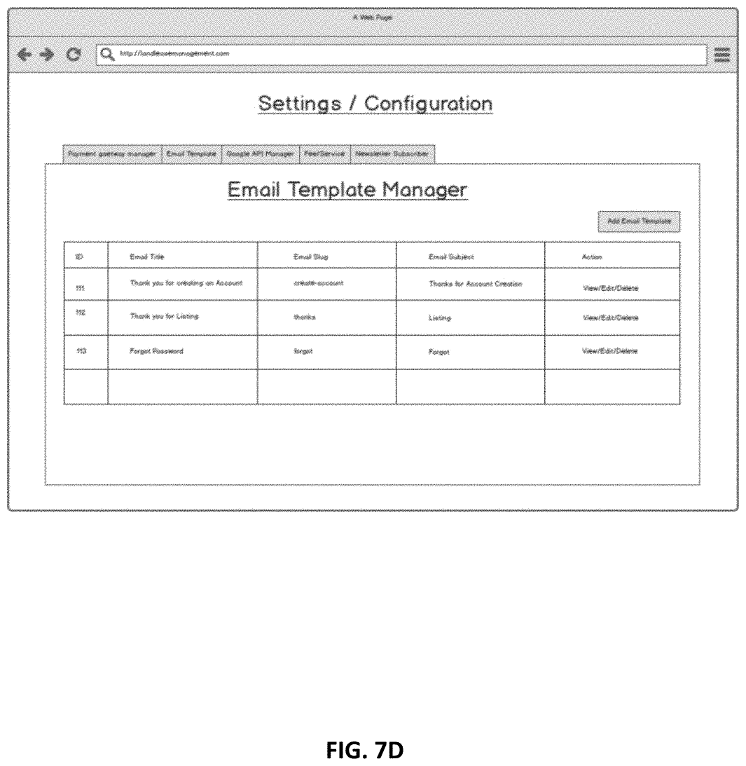

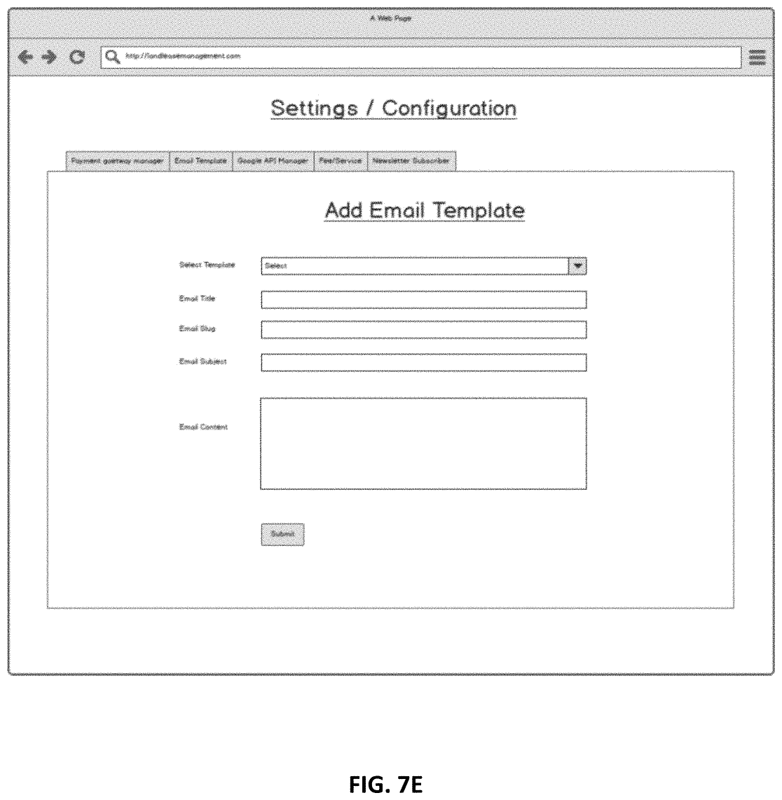

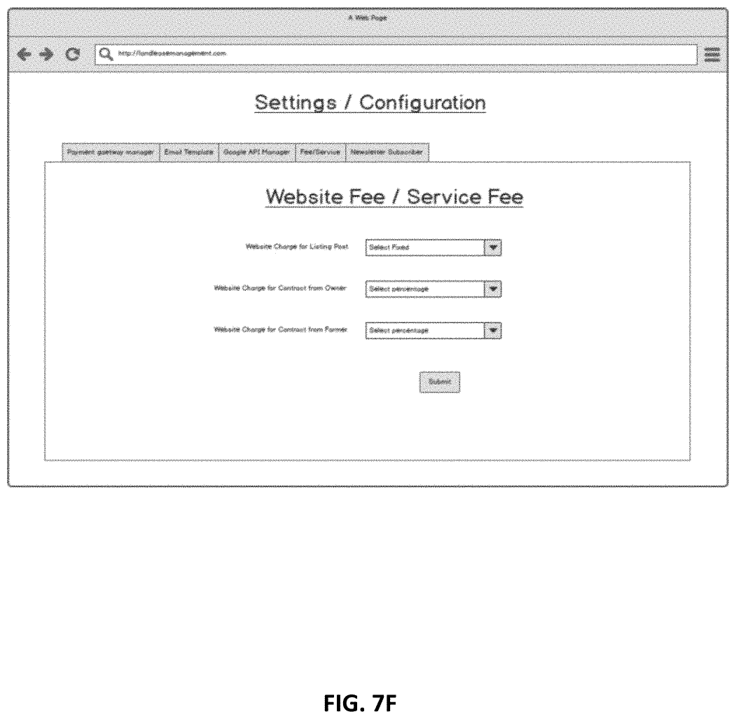

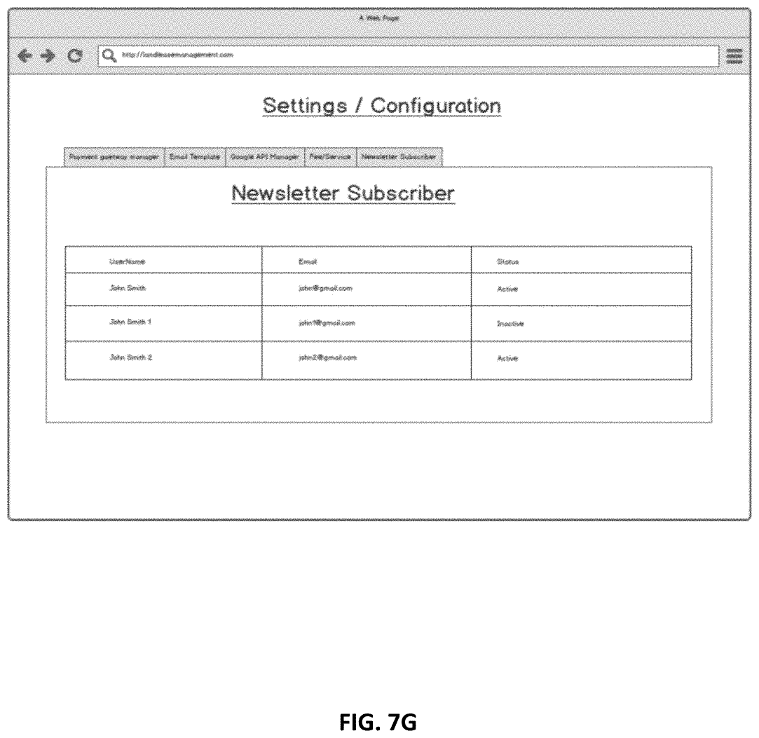

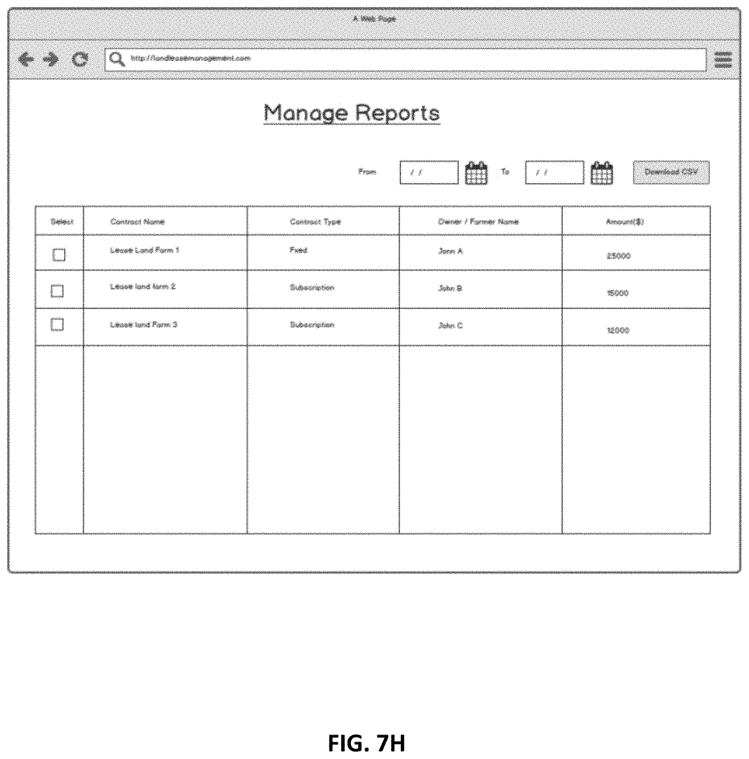

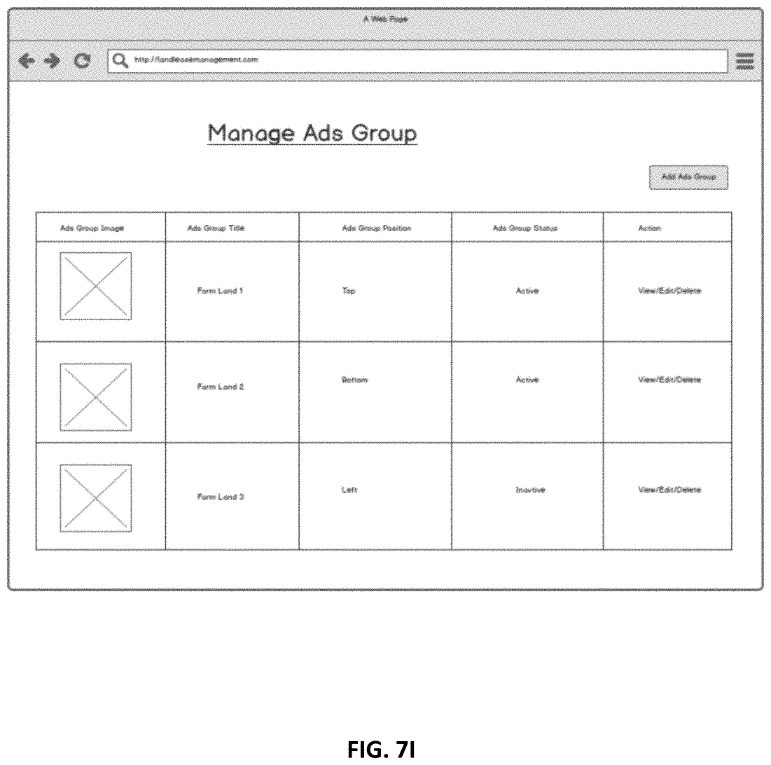

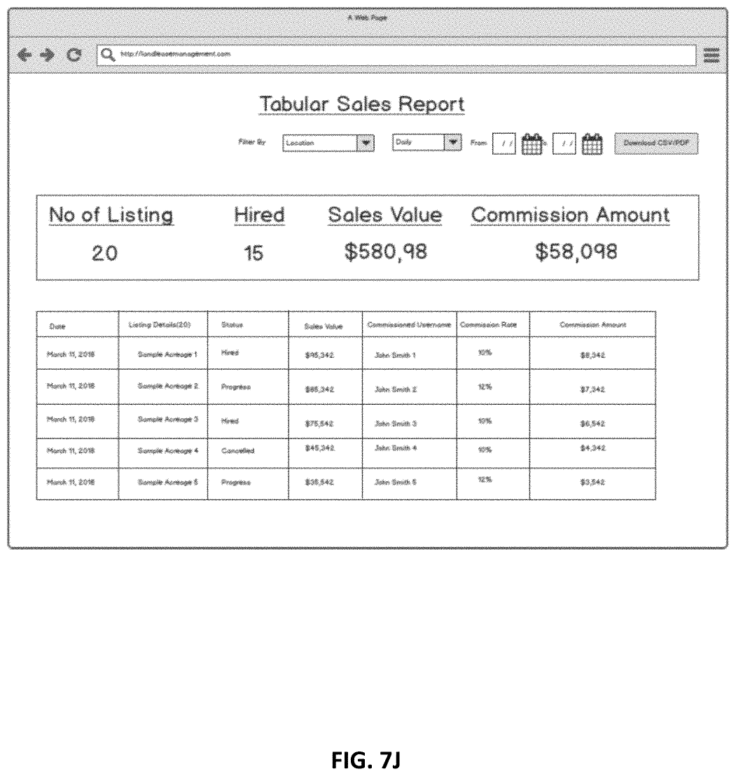

FIGS. 7A-J represent examples of the LSP 800, LRP 400, and ADP 300 as displayed on the worldwide web through the system GUI. These examples show listing management and administrative functionalities of the representative portals.

The systems and methods of the present invention may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality.

Whereas particular aspects of this invention have been described above for purposes of illustration, it will be evident to those skilled in the art that numerous variations of the details of the present invention may be made without departing from the invention.

Network and communication between the various modules may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into the network. Moreover, the network may be embodied as bi-directional links or as unidirectional links.

The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

1. At least one computing device comprising a non-transitory computer-readable storage medium having computer-executable program instructions stored thereon that when executed by a processor, cause the at least one computing device to:
display, by a computing device, a graphical user interface including instructions for creating an electronic land lease record and listing and processing an electronic land lease transaction including accessing a plurality of communicatively coupled subroutines configured to register user data, create electronic land lease listings, import land data into the land lease listing, transmit the land lease listings to lessees, facilitate a negotiation between a lessor and the lessee, and facilitate electronic payment between lessor and lessee.

2. The at least one computing device of claim 1 wherein the at least one computing device comprises a server having an externally networked cloud server having a front end graphical user interface hosting or in communication with the plurality of communicatively coupled subroutines.

3. The at least one computing device of claim 2 wherein the plurality of communicatively coupled subroutines comprises a user registration subroutine, a land data collection subroutine, a lessor portal subroutine, a lessee portal subroutine, and an administration portal subroutine.

4. The at least one computing device of claim 3 wherein the user registration subroutine retrieves registration data through preset or customizable data entry fields accessible through the graphical user interface of the computing device and transmits the registration data to a server and store the registration data in a user registration database.

5. The at least one computing device of claim 4 wherein the lessor portal subroutine transmits data entered through the computing device and graphical user interface to the server to create and manage electronic land lease records and transmit communication messages with lessee users, the lessor portal subroutine further transmitting and creating electronic land lease listing records including land data gathered through the land data collection subroutine and store the listings in a listings database on the server.

6. The at least one computing device of claim 5 wherein a lessor is presented with bids or offers on the electronic lease listing records and further accepts or rejects bids, offers, or makes counteroffers through the graphical user interface of the lessor portal subroutine.

7. The at least one computing device of claim 5 wherein the land data collection subroutine retrieves land data for a parcel of land identified by a lessor from a land data collection module data base or external networked land information database and the land data collection module transmits the land data to the electronic land lease listing records.

8. The at least one computing device of claim 6 wherein the land data for a particular user identified parcel of land is selected from at least one of: soil type, soil maps, crop types, average yield, and seasonal data.

9. The at least one computing device of claim 8 wherein a the lessor portal subroutine transmits a graphical map of an identified lessor parcel to the computing device and a lessor draws or identifies a specific portion of the identified parcel to be leased and transmits the specific portion through the lessor portal to the electronic land lease listing record.

10. The at least one computing device of claim 6 wherein the lessee portal subroutine retrieves land lease listing records for a lessee from the listing databases, transmit communications through the server to the computing device to communicate with lessor users, alert lessee users of new land lease listing records matching lessee user predefined criteria, bid on a land listing, and execute a land lease.

11. The at least one computing device of claim 6 the administration portal subroutine accesses and modifies data stored in the user registration database, land data collection module database, and listing database, modify any system subroutine or provision user security permissions, the administration portal subroutine further facilitates electronic payment between lessee users and lessor users.

12. The at least one computing device of claim 6 wherein at least one of the plurality of communicatively coupled subroutines collects preferred property characteristics from a licensee through the graphical user interface including at least one of the following characteristics: radial distance, price, location, soil type and crop type; and further transmits a notification to the licensee if an electronic land lease record is created mating the preferred property characteristics.

13. A method of providing electronic land lease services comprising:
receiving, by a server via a graphical user interface of a computing device having a non-transitory computer-readable storage medium having computer-executable program instructions stored supported by the server, user identifying data;
the server creating or modifying a user profile record with the user identifying data and categorizing the user profile record as a lessee or lessor in a user profile database; and
the server transmitting access to a lessor portal configured to create an electronic land lease listing record via the graphical user interface by inputting land lease data, mapping out land data corresponding to the electronic lease record through a land data collection module;
populating the land data into the electronic lease record; and
completing the electronic lease record and transmitting the electronic lease record to be accessible to a lessee through the graphical user interface.

14. The method of providing electronic land lease services of claim 13 further comprising:
the server retrieving a lessee through the graphical user interface, the server transmitting a lessee portal through the graphical user interface configured to identify an available electronic land lease listing record through lessee search criteria including at least one of at least one of the following characteristics: radial distance, price, location, soil type and crop type;
the server analyzing lessee search criteria against available electronic land lease records and presenting available electronic land lease listing records similar to the lessee search criteria;
the lessee transmitting a bid or offer on the an electronic land lease record through the lessee portal;
the server creating a final electronic lease based on the criteria and accepted bid, offer, or counter offer;
the lessor transmitting an acceptance, rejection, or counteroffer, through the lessor portal; and
the lessee transmitting payment through the server and the server transmitting payment to the lessor.

15. The method of providing electronic land lease services of claim 14 wherein the server comprises a plurality of communicatively coupled subroutines including a user registration subroutine, a land data collection subroutine, a lessor portal subroutine, a lessee portal subroutine, and an administration portal subroutine.

16. The method of providing electronic land lease services of claim 15 wherein the user registration module retrieves registration data through preset or customizable data entry fields accessible through the graphical user interface of the computing device and transmits the registration data to a server and store the registration data in a user registration database.

17. The method of providing electronic land lease services of claim 16 wherein the lessor portal transmits data entered through the computing device and graphical user interface to the server to create and manage electronic land lease records and transmit communication messages with lessee users, the lessor portal subroutine further transmitting and creating electronic land lease listing records including land data gathered through the land data collection module and store the listings in a listings database on the server.

18. The method of providing electronic land lease services of claim 17 wherein the land data collection subroutine retrieves land data selected from at least one of: soil type, soil maps, crop types, average yield, and seasonal data, for a parcel of land identified by a lessor from a land data collection module data base or external networked land information database and the land data collection module transmits the land data to the electronic land lease listing records.

19. The method of providing electronic land lease services of claim 18 wherein a the lessor portal transmits a graphical map of an identified lessor parcel to the computing device and a lessor draws or identifies a specific portion of the identified parcel to be leased and transmits the specific portion through the lessor portal to the electronic land lease listing record.

20. An electronic land lease system platform comprising:
a backend externally networked cloud server having a front end graphical user interface comprising a plurality of communicatively coupled subroutines including a user registration subroutine, a land data collection subroutine, a lessor portal subroutine, a lessee portal subroutine, and an administration portal subroutine;
the user registration subroutine configured to collect registration data through preset or customizable data entry fields accessible through the graphical user interface and store the registration data in a user registration database;
the land data collection subroutine configured to collect land data for a parcel of land identified by a lessor from a land data collection module data base or external networked land information database;
the lessor portal subroutine configured to create and manage electronic land lease records and provide a communication messaging system configured to communicate with lessee users, the lessor portal subroutine further configured to create electronic land lease listing records through land data gathered through the land data collection module and store the listings in a listings database;
the lessee portal subroutine configured to manage search land lease listing records in the listing databases, provide a communication messaging system configured to communicate with lessor users, alert lessee users of new land lease listing records matching lessee user predefined criteria, bid on a land listing, and execute a land lease; and
the administration portal subroutine configured to allow a system administrator to access and modify data stored in the user registration database, land data collection module database, and listing database, modify any system subroutine or provision user security permissions, the administration portal subroutine further configured facilitate electronic payment between lessee users and lessor users.
